(19) United States
(12) Patent Application Publication
(10) Pub. No.: US 2017/0102924 A1
(43) Pub. Date: Apr. 13, 2017

(54) SOFTWARE ARCHITECTURE FOR EMBEDDED SYSTEMS

(71) Applicant: Renesas Electronics America Inc., Santa Clara, CA (US)

(72) Inventors: Brandon Cranford Hussey, Durham, NC (US); Bhupesh Kharwa, San Ramon, CA (US); Jon Matthew Brabender, Cary, NC (US); Kristine M. Jassmann, Santa Cruz, CA (US)

(21) Appl. No.: 15/290,491

(22) Filed: Oct. 11, 2016

Related U.S. Application Data
(60) Provisional application No. 62/239,945, filed on Oct. 11, 2015.

(51) Int. Cl. G06F 9/44; G06F 9/45

(52) U.S. Cl. CPC G06F 8/33; G06F 8/41; G06F 8/315

(57) ABSTRACT

Provided herein are various systems, methods and architectures for enabling a microcontroller manufacturer to provide certain modification functionality to product vendors, while still maintaining the level of control needed to ensure that a product vendor does not inadvertently (or otherwise) create code that causes the microcontroller to not work properly. In one embodiment, this functionality can be performed through the steps of displaying an initial stack of software modules to a user, receiving instructions to modify the initial stack of software modules to create a modified stack of software modules, compiling the modified stack of software modules to produce compiled computer instructions, and flashing the embedded memory of the microcontroller with the compiled computer instructions.

### RELATED APPLICATIONS

This application claims the domestic benefit under Title 35 of the United States Code §119(e) of U.S. Provisional Patent Application Ser. No. 62/239,945, entitled “Microcontroller Development Platform,” filed Oct. 11, 2015, which is hereby incorporated by reference in its entirety and for all purposes as if completely and fully set forth herein.

### BACKGROUND OF THE INVENTION

In the embedded product domain, the embedded software applications provided with microcontrollers are often not production quality. That is, the software provided with the microcontroller is often insufficient for the specific needs of the product into which that microcontroller is to be embedded. As a result, the product vendor who purchased the microcontroller may need to modify the microcontroller's embedded software application before the embedded software application can be adequately used in the vendor's product. Such a product vendor may face numerous challenges, including a lack of familiarity with the underlying code (including variable names, function calls, dependencies, and so forth) used to code the embedded software application. Moreover, any resulting modifications must still effectively and carefully use the relatively-limited amount of memory available to a microcontroller and an embedded software application (particularly as compared to the much-greater amount of memory that is typically available to microprocessors as used in devices such as general purpose computers). Therefore, embedded software applications must use the memory judiciously and efficiently. Moreover, any customizations or modifications must also comply with various other constraints that are specific to a given microcontroller model. Accordingly, there exists a need to provide product vendors with an interface and the related functionally that enables the product vendor to modify the microcontroller's embedded software application(s) with sufficient detail to meet the product's needs, but without having to deal with the memory issues and other constraints associated with typical object oriented programming languages or the complexities of using various software stacks within an embedded software application.

### SUMMARY OF THE INVENTION

The systems and methods provided herein enable a microcontroller manufacturer to provide certain modification functionality to product vendors, while still maintaining the level of control needed to ensure that a product vendor does not inadvertently (or otherwise) create code that causes the microcontroller to not work properly.

### BRIEF DESCRIPTION OF THE DRAWINGS

The present invention may be better understood in its numerous objects, features, and advantages made apparent to those skilled in the art by referencing the accompanying drawings.

FIG. 1 is a block diagram illustrating certain components of an example microcontroller, according to one embodiment.

FIG. 2 is a block diagram illustrating an example embedded software application including multiple SSP software modules aligned in multiple stacks and multiple layers, according to one embodiment.

FIG. 3 is a block diagram illustrating an example set of relationships between three software modules aligned in a single, three-layer stack, according to one embodiment.

FIG. 4 is block diagram illustrating an example set of relationships between multiple modules aligned in a single stack with two alternate branches, according to one embodiment.

FIG. 5 is a flowchart that illustrates actions that can be performed by the systems and methods described herein, according to one embodiment.

FIG. 6 is a block diagram of a computing device, illustrating how certain features of the invention disclosed herein can be implemented in software, according to one embodiment.

### DETAILED DESCRIPTION

Microcontrollers were originally programmed only in assembly language, but various high-level programming languages are now also in common use to target microcontrollers. These languages are either designed specifically for the purpose, or versions of general purpose languages such as the C programming language. Compilers for general purpose languages typically have some restrictions as well as enhancements to better support the unique characteristics of microcontrollers. Some microcontrollers have environments to aid developing certain types of applications. Microcontroller vendors often make hardware development platforms freely available to make it easier to adopt their hardware. These platforms include software tools for developing and/or debugging applications.

In the past engineering teams used to spend valuable development time writing software ranging from low-level peripheral drivers to complex communication and specialty stacks for microcontrollers. This resulted in months of engineering resources spent integrating, testing, and maintaining software that still did not differentiate the vendor's product in the market.

Disclosed herein are systems and methods that allow product vendors to interact with microcontroller platforms at a much higher level and much more efficiently than would have been possibly previously. The disclosure provided herein describes a software pack (or “SP,” and which is sometimes referred to as a Synergy SP, or “SSP”) in greater detail. Included in this disclosure are apparatuses and methods for improving developing, customizing, debugging, and so forth, of microcontroller applications.

Microcontrollers are often embedded in other machinery or products, and include embedded software application(s) that are specifically designed to control or otherwise interface with the specific product in which the microcontroller is embedded. As will be discussed in more detail below, embedded software applications can be “flashed,” uploaded, or otherwise stored (or modified or changed) in a memory on the microcontroller, after the microcontroller has been manufactured and sold. Thus, as can be seen from the disclosure provided herein, microcontrollers stand in contrast to the microprocessors used in general purpose computers or other general purpose applications.

By reducing the size and cost through the use of microcontrollers, particularly as compared to a design that uses a separate microprocessor, memory, and input/output devices, microcontrollers make it economical to digitally control many devices and processes. However, despite their many advantages particularly in the embedded space, microcontrollers typically have much less available memory than microprocessors because components such as the memory and CPU are built directly onto the chip. Moreover, the memory embedded in a microcontroller cannot easily be “swapped out” or “added to,” as is the case with the external memory devices that are typically connected to microprocessors. As such, making optimal use of a microcontroller's very limited memory is of the utmost importance when programming embedded software applications for use with microcontrollers. Such constraints are much less significant when dealing with programs that are designed for use with microprocessors.

### Example Microcontroller Architecture

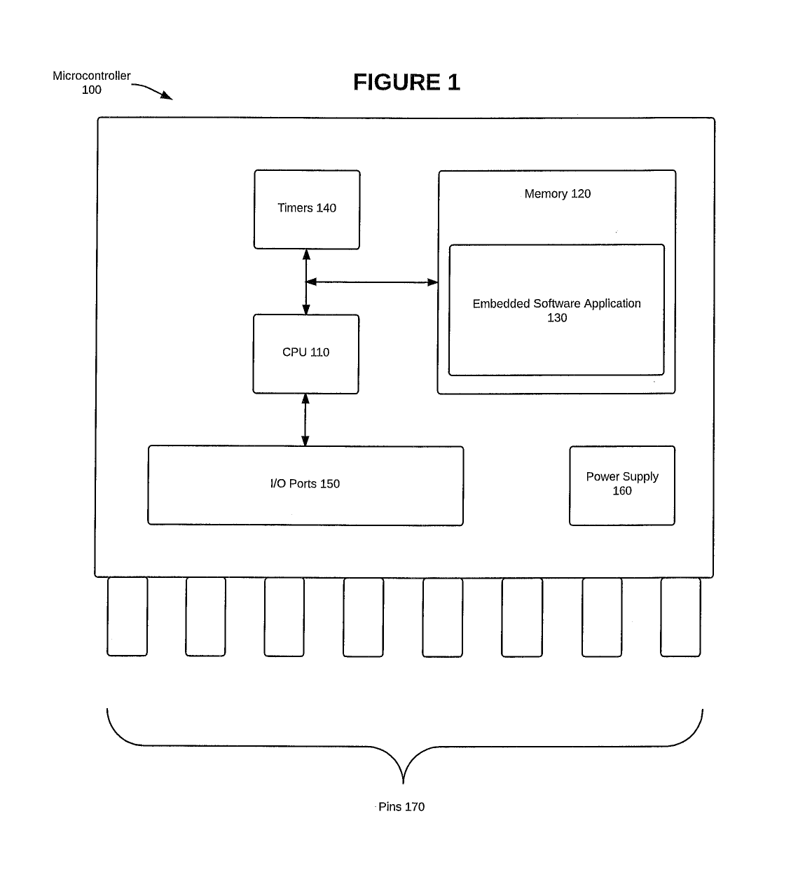

FIG. 1 is a block diagram depicting a microcontroller 100, according to one embodiment of this invention. As shown in FIG. 1, microcontroller 100 includes an embedded CPU 110, a memory 120 that includes an embedded software application 130, timers 140, I/O ports 150, a power supply 160, and a set of pins 170, each of which will be discussed in more detail below. Moreover, although not expressly depicted in FIG. 1 but as would be understood to one skilled in the art, microcontroller 100 can include numerous other components and functionality, including at least additional pins and various other components that contribute to the functionality of microcontroller 100. Additionally, microcontroller 100 can include an operating system, such as, e.g., a real-time operating system, or “RTOS.” In one embodiment, the RTOS (or other operating system) is stored in memory 120, along with embedded software application 130. In certain embodiments, memory 120 can store more than one embedded software application, as well as other potential software, data, and information.

A microcontroller (sometimes abbreviated μC, uC or MCU), such as microcontroller 100, is a small computer on a single integrated circuit, or “chip.” Unlike microprocessors, which are typically designed to interface with memories and other components that are external to the microprocessor, microcontrollers typically contain multiple components on a single chip. As such, microcontrollers typically contain at least a central processing unit (CPU), such as CPU 110; one or more non-transient memories, such as memory 120; timing functionality, such as can be provided by timers 140; programmable input/output peripherals, such as I/O ports 150; a power supply, such as power supply 160; and multiple pins, such as pins 170, among other components that are all provided on a single chip. Thus microcontrollers stand in stark contrast to microprocessors, as the aforementioned components are typically externally connected to microprocessors, rather than being included on a single chip, as is the case with microcontrollers.

As a result of the architectural differences between microprocessors and microcontrollers, microcontrollers are often more suitable for use in dedicated applications, whereas microprocessors are often more suitable for use in larger, general-purpose computers. Thus, in one sense, the use of a microcontroller is highly advantageous with respect to dedicated applications and the “embedded space,” among other uses. For instance, microcontrollers can be used in automatically controlled products and devices, such as automobile engine control systems, implantable medical devices, remote controls, office machines, appliances, power tools, toys and other embedded systems. In another sense, however, microcontrollers face a unique set of challenges, such as those discussed herein, and those challenges are particularly with respect to coding and modifying embedded software applications.

In a typical microcontroller, such as microcontroller 100, memory 120 can include program memory, RAM, ROM, and/or flash memory, and is typically embedded directly on the microcontroller. Memory is typically significantly more limited on a microcontroller than is the case when dealing with microprocessors. For instance, microcontroller memory typically ranges from 128 kilobytes (KBs) of ROM (or flash memory) to 4 megabytes (MBs) of ROM (or flash memory), and perhaps more or less in certain situations. The ROM is not typically an issue, although the use and allocation of RAM can create significant programming constraints and runtime problems if not properly handled during programming. In fact, some microcontrollers may have as little as 16 kilobytes (KBs) of RAM, which can be fully allocated very quickly, particularly when done so dynamically.

The aforementioned constraints become especially problematic when an embedded software application uses the heap, such as when an object oriented programming (“OOP”) language is used to code an embedded software application, which is due to the heap's memory being located in the RAM. The heap is used to dynamically allocate memory, which provides more programming flexibility than a static memory array. For instance, instead of creating and using a 1 KB static array, a program (such as, e.g., an embedded software application) may instead create and use a 2 KB memory heap that can be allocated dynamically. If an embedded software application is configured to always use a buffer (e.g., a communications buffer) of a certain size, then the application can allocate the buffer for that purpose and have certainty in this regard. But if the embedded software application is not configured to always use that buffer, then allocating a predetermined and specific amount of RAM (e.g., 1 KB out of 16 KBs of RAM that may be available) can be a big concession. On a larger computer with more memory, such as one controlled by a microprocessor, such a concession regarding allocating memory in this manner (e.g., dynamically) is usually not a problem. But when a program (such as embedded software application 130) is configured to operate on a microcontroller, which typically has relatively limited amounts of memory (e.g., often 16 KBs of RAM or less), allocating memory in this manner can be burdensome. Moreover, depending on the specific field in which the product is being used, running out of memory can create a very big problem, such as, e.g., in the case of a product being used in the medical field.

Moreover, since the memory is embedded directly on the microcontroller, the memory cannot be easily expanded, increased, or “swapped out,” as is the case with the memory used by most microprocessors (such as, e.g., in a general purpose desktop or laptop computer). Because memory is limited, embedded software applications, such as embedded software application 130, should preferably allocate memory statically to avoid any chance of running out of memory (such as, e.g., at run time). If an embedded software program instead uses the heap and/or allocates memory at run time, then there is a very real chance that the system will run out of memory (such as, e.g., at run time or during the operation of the product into which the embedded software application is embedded).

Moreover, microcontroller embedded software applications must typically fit in the available on-chip program memory, since it would be costly to provide a system with external, expandable, memory. Compilers and assemblers are used to convert high-level language and assembler language codes into a compact machine code for storage in the microcontroller's memory. Depending on the device, the program memory may be permanent, read-only memory that can only be programmed at the factory, or program memory that may be field-alterable flash or erasable read-only memory. The use of field-programmable devices on a microcontroller may allow field update of the firmware or permit late factory revisions to products that have been assembled but not yet shipped. Programmable memory also reduces the lead time required for deployment of a new product. A customizable microcontroller incorporates a block of digital logic that can be personalized in order to provide additional processing capability, peripherals and interfaces that are adapted to the requirements of the application.

Thus, coding and modifying an embedded software application while still optimizing the allocation and use of a microcontroller's memory is quite challenging and subject to errors that can be significant, costly, and even potentially deadly (such as when dealing with devices in the field). These problems only become exacerbated when the embedded software application is being modified by a product vendor who did not create the microcontroller and who also did not code the original embedded software application. Moreover, product vendors face additional challenges when modifying an embedded software application, since such embedded software applications often contain multiple software modules, which were often coded by other (and perhaps multiple) companies. The disparate manner in which embedded software applications are often created can very often cause a product vendor to be unfamiliar with variable names and usage, function calls, parameters, and so forth, within the various modules and overall embedded software application. The constraints and challenges discussed herein also make it harder for a programmer (such as, e.g., a product vendor who did not manufacture the original microcontroller) to get software certified according to various standards.

The aforementioned factors (and other differences from typical systems that use microprocessors) become especially important when selecting the language used to code an embedded software application, such as embedded software application 130. Computer software libraries, such as can be found in many programming languages, such as, e.g., C++ and Java, are less than ideal (although they can be used) in the embedded space. For instance, if a program only needs a small portion of a library, object oriented programming (“OOP”) languages often require a program to import an entire library to have access to the needed portion of code. When dealing with software applications designed to run on standard computers (e.g., laptop or desktop computers), importing an entire library for the sake of only one (or some) command(s) is not a problem because such computers typically have an abundance of available memory. However, when memory is limited, as is the case in most products containing an embedded microcontroller, such functionality is not a viable option.

Moreover, while OOP languages offer many benefits to a programmer and are often easier to use for coding purposes, such languages also tend to produce executable code that consumes a lot of memory. At the other end of the spectrum, assembly language allows for more control over memory issues but is much harder for a programmer to learn and use. A language such as C provides a good balance between these various considerations, and as an added benefit, can also be compatible with C++, if needed. Thus, in one embodiment, the C programming language is a good choice for coding embedded software applications, such as embedded software application 130.

However, even the C programming language provides a certain set of challenges, especially to product vendors attempting to modify an embedded software application that was originally coded by other programmers working for one or more distinct companies. For instance, the C programming language is not always easy for less-experienced programmers to use, especially when they are attempting to modify an embedded software application created by someone else, and even more so when they are attempting to modify that embedded software application without knowledge of the underlying code used to create the original embedded software application. As such, and as will be discussed in more detail below, the need exists for a product that provides product vendors with the flexibility needed to customize embedded software applications to work with their specific products, while also taking into account the memory constraints, coding complexities, and other issues discussed herein.

In addition to the aforementioned features and constraints, microcontroller 100 also includes timer 140, which can provide timing functionality for microcontroller 100. Although represented somewhat generically in this Figure, in practice timer 140 can be a device such as, e.g., a timer, event counter, and/or clock generator. Microcontroller 100 also includes I/O ports 150, which provide input-output functionality such as, e.g., discrete input-output bits and/or serial ports. Microcontroller 100 also includes power supply 160, and a set of pins 170. In practice, microcontroller 100 can include more or less than eight pins, and can (and typically does) include pins on other edges or sides of the chip. Moreover, microcontroller 100 can also include numerous other components that are not expressly depicted in FIG. 1.

Some microcontrollers may operate at clock rate frequencies as low as 4 kHz, which provides for low power consumption. Microcontrollers will generally have the ability to retain functionality while waiting for an event such as a button press or other interrupt. However, power consumption while a microcontroller is in a “sleep” or wait mode (such as, e.g., when CPU clock and most peripherals are off) may be very small, making many of them well suited for long-lasting battery applications. Other microcontrollers may serve performance-critical roles, where they may need to act more like a digital signal processor (DSP), with higher clock speeds and power consumption.

Microcontrollers must provide real time (predictable, though not necessarily fast) response to events in the embedded system they are controlling. When certain events occur, an interrupt system can signal the CPU to suspend processing the current instruction sequence and to begin an interrupt service routine (ISR, or “interrupt handler”). The ISR will perform any processing required based on the source of the interrupt, before returning to the original instruction sequence. Possible interrupt sources are device dependent, and often include events such as an internal timer overflow, completing an analog to digital conversion, a logic level change on an input such as from a button being pressed, and data received on a communication link. Where power consumption is important in battery operated devices, interrupts may also wake a microcontroller from a low power sleep state where the CPU is halted until required to perform a specific action, such as can be caused by a peripheral event.

### Expanded View of Embedded Software Application Architecture

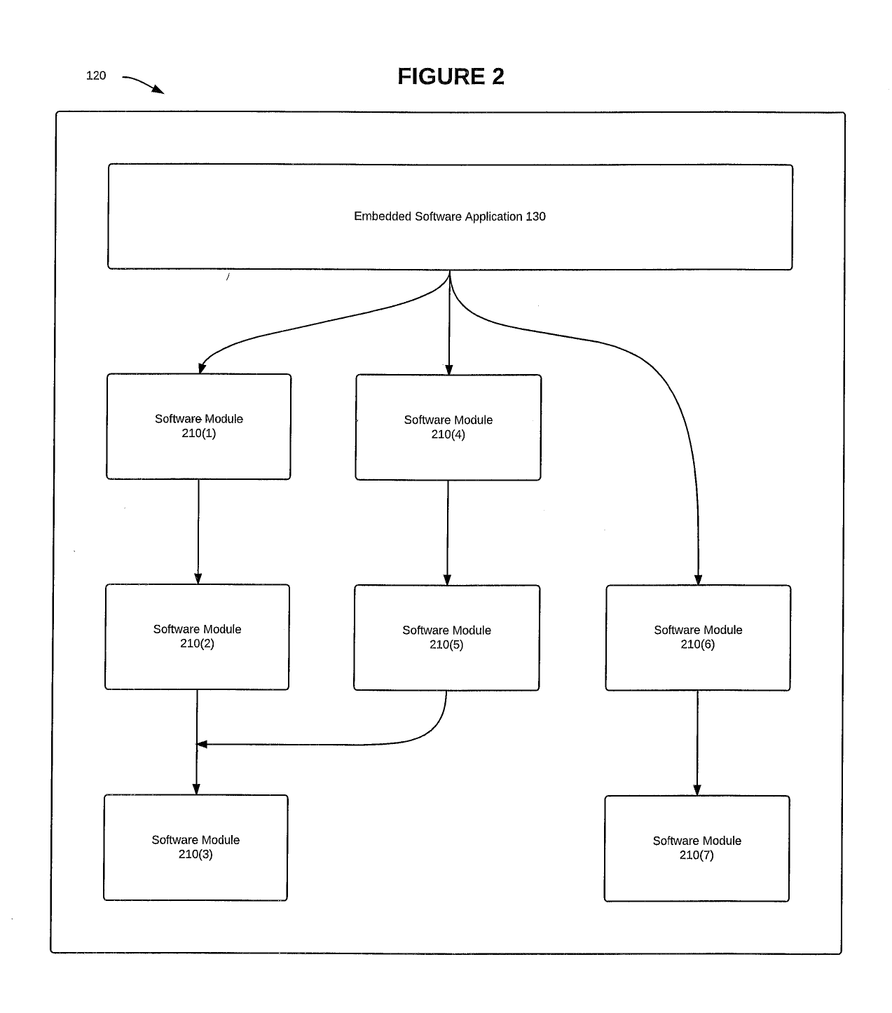

FIG. 2 is a block diagram depicting certain aspects of memory 120 of microcontroller 100, including embedded software application 130, and software modules 210(1)-(n). In accordance with one embodiment of this invention, software modules 210 are arranged in three vertical stacks, and cover three horizontal layers. Although this example architecture is used to facilitate the discussion provided in this disclosure, in practice many other combinations and amounts of software layers, stacks, and layers can be used.

Embedded software application 130 can be any embedded software application (“embedded application”). As an example, embedded software application 130 can be software designed to control or provide other functionality for a specific product, and which can be embedded in that product. For instance, microcontrollers can be used in automatically controlled products and devices, such as automobile engine control systems, implantable medical devices, remote controls, office machines, appliances, power tools, toys and other embedded systems.

Embedded software applications differ from traditional software programs and software operating systems at least because embedded applications face significant memory constraints. For example, due largely to the practical constraints of the product in which the embedded application is embedded, as well as cost issues associated with many forms of memory, an embedded application may only have access to 2 MB of memory. Such memory constraints affect numerous aspects of an embedded application, including how the embedded application manages run-time memory (such as, e.g., the heap) as well as how the embedded application itself is coded. Due to the overall memory constraints of embedded devices, there exists a great need to only include the specific functionality that is absolutely necessary for the embedded application to function properly, without necessarily including entire software libraries such as is often done, e.g., when using object oriented programming (“OOP”) languages (such as Java and C++) to code software programs. At the same time, this need for precise and limited memory allocation must be balanced against the need of embedded device manufacturers (who generally do not manufacture the microcontrollers themselves) to modify the embedded applications that control a given embedded device, while still being subject to the constraints above, among other such constraints.

Moreover, many embedded software applications include multiple software stacks, such as is depicted in FIG. 2. For instance, software modules 210(1)-(3) constitute one stack, software modules 210(4)-(5) constitute a second stack, and software modules 210(6)-(7) constitute a third stack. As is also shown in FIG. 2, each of those software stacks includes multiple layers of software modules, such as software modules 210(1) and 210(4) in layer 2, software modules 210(2), 210(5), and 210(6) in layer 1, and software modules 210(3) and 210(7) in layer 0. Although FIG. 2 depicts one stack that includes three software modules, and two stacks that each include two software modules, in practice a stack may include less than two (i.e., one) software modules or more than three software modules. Moreover, a given embedded software application may include more or less than three stacks of software modules. The relationships between these software modules will be discussed in more detail below. For the time being, it should suffice to say that certain dependencies exist among software modules within a given stack, but one stack of software modules is not necessarily dependent upon information generated, produced, or “returned” by software modules in another stack.

In practice, software modules such as these are often developed by different companies, with different rules, variables, function calls, and so forth. Even where all of the software modules are developed by the same company, the company which initially developed and coded those software modules is most likely distinct from the product vendor company that must modify one or more of those software modules in order to adequately use the microcontroller in the vendor company's product(s). Thus, the complexities of these software modules, as well as the relationships between these software modules, can make modifying one or more of these software modules very challenging, particularly where the person or company performing the coding modification is different from the person or company who originally coded the software module(s) and/or embedded software application.

Prior to the creation of the systems and methods disclosed herein, product vendor faced a difficult task when attempting to modify or customize embedded software applications and their incumbent software modules for use in a specific dedicated product, examples of which are provided elsewhere in this disclosure. For instance, before any such customization was even possible, a product vendor (who did not manufacture the microcontroller or code the original embedded software application) faced a challenging task just in attempting to figure out how all of the software stacks and modules relate to each other, let alone figuring out how to modifying the various code sources without “breaking” the overall embedded software application. Thus, any such modifications were costly, time consuming, and inherently risky, since the modification could easily “break” the embedded software application and thereby prevent the proper functioning of the microcontroller and/or the vendor's product into which the microcontroller is embedded. Moreover, different microcontrollers are configured differently with respect to various aspects of their functionality, such as, e.g., memory, processor speed, and so forth. These variables and potential configurations further add to the complexity faced by product vendors in modifying an embedded software application to work for a given microcontroller within a product vendor's specific product(s).

### Software Module Stack and Relationships

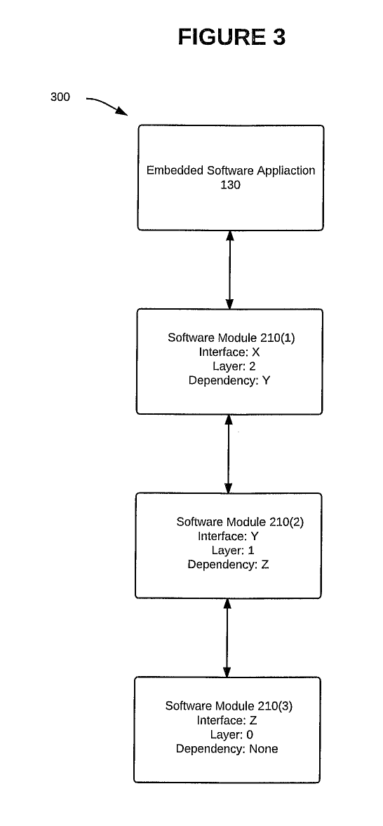

FIG. 3 is a block diagram illustrating an example set of relationships between three software modules aligned in a single, three-layer stack 300, according to one embodiment. More specifically, FIG. 3 depicts the leftmost “stack” of FIG. 2 as one example of a stack of software modules, including software modules 210(1)-(3), which are logically and schematically connected to embedded software application 130. In practice, these connections can represent any method of transferring information between connected software modules, and/or between an embedded software application and any module directly connected to it.

Every software module will provide some functionality. In addition to supplying functionality (as output), a software module may also have a input requirement, or dependency, that must be met in order to work. As can be seen from the additional detail provided by FIG. 3, each software module 210 includes an interface and, at least potentially, has a dependency based on information needed from another software module. The relationships between these interfaces and dependencies enable the software modules to be “stacked” by matching the information that one software module provides with the information that another software module requires in order to function properly.

An interface defines a set of functionality that must be supported by any module that adheres to that interface. In a sense, an interface provides an agreed upon “contract” between two software modules. Interfaces can be built from various data structures, such as, e.g., “typedefs,” enumerations, and macros, as some examples. In one embodiment, the functionality defined by an interface can take the form of an Application Program Interface (“API”).

Interfaces can vary in size, complexity, and functional specificity. Some interfaces can have narrow use cases where the configurability of the interface is clearly defined. Other interfaces will support many different types of use cases. Where many use cases are supported, the level of configurability specified by the interface may be limited to allow for maximum reuse. Conversely, the interface extension of a software module implementing the interface may be larger than the original interface itself.

Interfaces allow a user (such as, e.g., a product vendor, or the employees or contractors thereof) to modify software modules and swap modules in and out of a software stack without having to access and/or modify the underlying code itself. This structure and functionality enables users to swap modules in and out to suit their needs, but without any risk of introducing errors into (or otherwise compromising the integrity of) the underlying code.

Software modules that have an interface requirement must adhere to that interface. At least potentially, each module can also include a dependency, although some software modules may not be dependent on information received from any other module. If a software module has a dependency requirement, that dependency requirement will be for information received from another interface pursuant to the definition of that interface. For example, software module 210(1) is dependent on information received from interface Y, which is the interface of software module 210(2). Software module 210(2) is, in turn, dependent on information received from interface Z, which is the interface of software module 210(3). Software module 210(3), which is at layer 0 of the stack, contains interface Z and thus can provide information to software module 210(2) according to the constraints and parameters of interface Z. However, software module 210(3) is not itself dependent on information received from any other software module in this stack. Moreover, embedded software application 120, which is shown at the “top” of this stack, is configured to receive and use information from software module 210(1), as defined by interface X.

Importantly, software modules that do not “match” cannot be stacked directly on top of each other. For instance, using FIG. 3 as an example, software module 210(1) cannot be stacked directly on top of software module 210(3) without having software module 210(2) (or another software module that has the same interface and dependency as those of software module 210(2)) in between them. Stacking software module 210(1) directly on top of software module 210(3) would not work because software module 210(3) provides information according to interface Z, which would not be properly understood by software module 210(1), which has a dependency that requires information provided by interface Y. Moreover, stacking software module 210(1) directly on top of software module 210(3) would cause a further problem in that software module 210(1) is dependent on information provided by interface Y, which software module 210(3) does not and cannot provide in this example embodiment. Thus, if software module 210(1) was stacked directly on top of software module 210(3), software module 210(1) would receive information that it is not programmed to handle (from interface Z), but would not receive the information that is required for software module 210(1) to function properly (from interface Y).

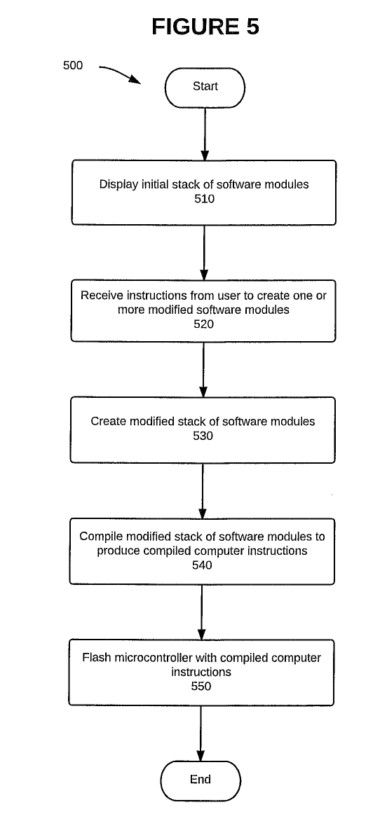

As will be discussed in more detail below, the use of predefined interfaces enables software modules and even entire stacks of software modules to be swapped in and out by vendors. Microcontroller manufacturers often have a wide range of products that they offer, ranging from lower end products to higher end products. The different products have different features. If, for example, a microcontroller manufacturer may release a demonstration product using a high end microcontroller, but a vendor may want to use a lower end microcontroller in their product instead. As a result, the product vendor may have to modify one or more software modules in order to use the lower end microcontroller in its product. As one example, if a demonstration product is designed to work on a higher end microcontroller, certain application functionality may be incompatible with a vendor's product that uses a lower end microcontroller. As will be discussed in additional detail with respect to FIG. 5, below, the systems and methods described herein enable vendors to swap out incompatible software stacks and replace them with software stacks or modules that are compatible with their system and products while avoiding the numerous problems described throughout this disclosure (e.g., compatibility, dependencies, memory constraints, the general operability and reliability of the resulting code, the need for certain code to be certified, and so forth).

### Example of Module Instances

Moreover, there can be differences between software modules that adhere to the same interface. For example, a given software module may offer more functionality than is exposed in an existing interface. In such a situation, a module-specific interface extension can be used. These extensions allow software modules to expose further configuration options without breaking the adherence requirements of an interface.

Software modules can also support multiple uses simultaneously. Each independent use of a software module is referred to herein as a module instance. A module that implements an interface is called an instance. Instances can be swapped out to meet the requirements of a given product's design. Moreover, interfaces can allow for the use of instance-specific interface extensions, which can be used to provide specialized features that are not exposed in an interface itself. Interface extensions allow for extra features to be enabled in an instance.

For instance, a product vendor may desire to control the “pin out” of a microcontroller. Pin out refers to the pins protruding from a chip, such as, e.g., a microcontroller. Pins enable a microcontroller to communicate with other components of a device in order to make various actions occur. Different microcontroller designs can have a variable number of pins (e.g., from 34 to 244 pins) that enable a microcontroller to interface and communicate with other products. The function of a given pin is often not statically assigned, but rather each pin may have a multiple available options. However, vendors often want to choose a specific function for each pin and statically assign that function to that pin prior to the production of the vendor's larger product. The systems and methods provided herein enable a user to make such a determination and assignment to the pins (e.g., to set the “pin out”) in order to meet their specific needs. At the same time, providing this functionality to the vendors allows the vendors the flexibility that they need without requiring the microcontroller manufactures to provide an unnecessarily-high number of pins, which would unnecessarily increase the cost of the microcontroller (and thus increase the cost of the vendor's products as well). The architecture, systems and methods disclosed herein enable a software program (such as, e.g., a Synergy Software Pack) to support the functionality that a product vendor wants a chip (e.g., microcontroller) to perform.

Moreover, in order to support a varying number of module interfaces at runtime, the resources required for a module instance can be specified at runtime. This can be supported by configuring every module to have a control structure. The control structure holds resources required for a module instance. In one embodiment, a pointer to a control structure can be the first parameter in every interface function that is based on a module instance. An example of a function that is not based on a module instance is a function that returns the version of a module.

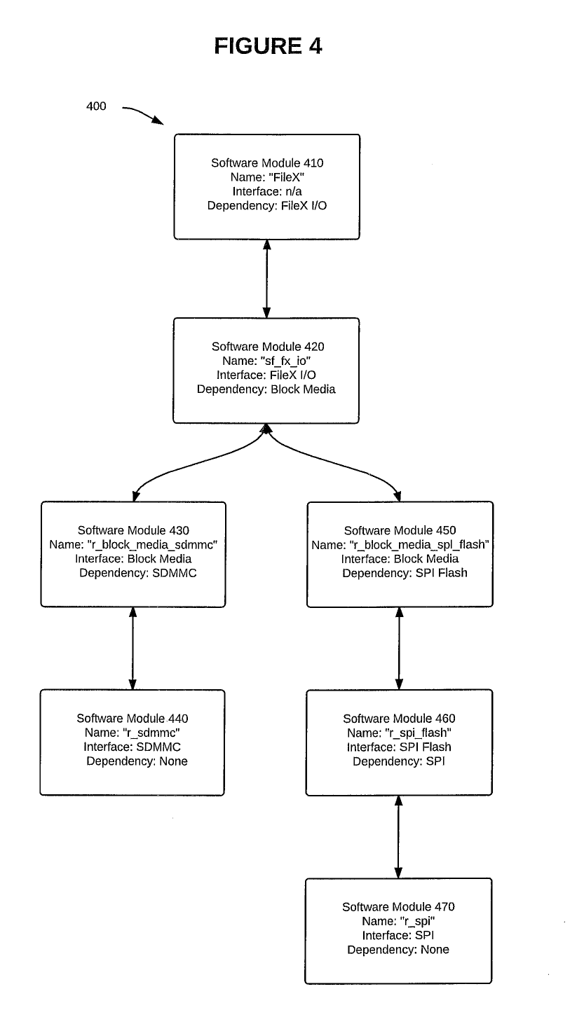

As will become clear from the discussion of FIG. 4, below, a given interface can be implemented on a variety of module instances. For instance, FIG. 4 shows the “Block Media” interface being implemented on both the “r_block_media_sdmmc” module as well as on the “r_block_media_spi_flash” module. Both of these modules produce output according to the same interface, but as will be discussed in more detail below, both of these modules also have many differences, including the “dependency” that each module accepts as input.

The systems, method, and architecture described herein allows for product vendors (and other programmers) to expand upon the default interfaces provided with the original embedded software application provided by the microcontroller's manufacturer. At the same time, requiring software modules to adhere to an interface ensures that new software modules can be created for the same interface after the original embedded software application was coded, and even after the embedded software application has been modified. That is, multiple rounds of modification are possible. Such expandability of the interfaces is also possible inside of an interface. That is, data structures that are used in any case where a specific feature or features is needed can be expanded to meet future needs.

To add more specificity to the above description, by way of example, consider a stack such as the one shown in FIG. 4. FIG. 4 is a block diagram illustrating an example set of relationships between multiple software modules. More specifically, FIG. 4 depicts a set of software modules that constitute a portion of a file system that can be used in conjunction with a real-time operating system of a microcontroller. In the specific embodiment depicted in FIG. 4, the file system is the FileX® file system created by Express Logic, Inc.®, which has its United States headquarters in San Diego, Calif.

FIG. 4 includes a stack 400 that includes seven software modules, numbered 410 through 470. These software modules are specific embodiments of software modules 210, and thus share many definitional characteristics with software modules 210. As can be seen in FIG. 4, software module 410 is named “FileX,” and represents a portion of the aforementioned FileX® file system. Software module 410 does not include an interface, since there is no other module that is dependent upon information from software module 410 in this embodiment. Software module 410 does, however, have a dependency for information received from the “FileX I/O” interface, which can be found in software module 420.

As can be seen in FIG. 4, software module 420 is named “sf_fx_io,” which in this embodiment is indicative of the role and functionality of software module 420. As one of skill in the art would recognize, a software module's name does not necessarily have to correspond to its function, although naming software modules in this manner is generally considered to be a good programming practice. Software module 420 provides information to software module 410 via the “FileX I/O” interface, and software module 420 is also dependent upon information received from other software modules via the “Block Media” interface.

In the embodiment shown in FIG. 4, software module 430 and software module 450 both provide information to software module 420 via the “Block Media” interface. However, software module 430 and software module 450 each receive information from different interfaces. As its name and dependency both indicate, software module 430 receives information via the SDMMC interface. As one of skill in the art would recognize, the SDMMC interface allows a microcontroller to communicate (via software modules and/or an embedded software application) with various external memory devices that use the SDMMC interface, such as, e.g., multimedia cards, memory cards, SDIO devices, and flash memory devices. In the embodiment depicted in FIG. 4, software module 440 provides information to software module 430 via the SDMMC interface. In one embodiment, software module 440 may be integrated within an external memory device, such as those discussed herein. In other embodiments, other configurations are possible.

In contrast to software module 430, software module 450 receives information via the Serial Peripheral Interface (“SPI”) Flash interface. The SPI Flash interface is provided by software module 460, which itself receives information from software module 470 via the SPI interface. As one of skill in the art would recognize, the SPI interface allows a microcontroller to communicate (via software modules and/or an embedded software application) with various external memory devices that use the SPI interface. Although not necessarily so limited, SPI is often used to connect external devices, such as, e.g., cameras, printers, and scanners. In the embodiment depicted in FIG. 4, software module 470 provides information to software module 460 via the SPI interface. In one embodiment, software module 470 may be integrated within an external memory device, such as those discussed herein. In other embodiments, other configurations are possible.

Thus, the architecture of FIG. 4 enables software module 420 to receive information from either a device that supports the SDMMC interface (via software modules 430 and 440), or from a device that supports the SPI interface (via software modules 450-470). As was alluded to above, the decision as to whether software module 420 receives information that began at an SDMCC-enabled device or at an SPI-enabled device is a decision that can be made at runtime, depending on which sort of device is connected to a product that includes the necessary software modules to support this functionality. As was indicated elsewhere, the architecture of FIG. 4 is provided as an example of the type of functionality that can be provided by the systems, methods and architecture disclosed herein, but is not in any way intended to limit the use of this disclosure to this one specific example, which again is provided primarily for the purposes of explanation and discussion.

### Example Method for Using Synergy Software Package (SSP)

FIG. 5 is a flowchart of method 500 illustrating various actions performed in connection with one embodiment of the systems and methods disclosed herein. As will also be appreciated in light of the present disclosure, this method may be modified in order to derive alternative embodiments. Moreover, although the steps in this embodiment are shown in a sequential order, certain steps may occur in a different order than shown, certain steps may be performed concurrently, certain steps may be combined with other steps, and certain steps may be omitted in another embodiment.

Method 500, which is described with reference to the example elements shown in FIGS. 1-4, shows a procedure that can be performed by a software program in accordance with this disclosure. More specifically, method 500 depicts a method for modifying one or more stacks of software modules in an embedded software application.

Method 500 begins at step 510, in which a software program displays an initial stack of software modules to a user, such as an engineer of the product vendor. The user can then determine which software module(s) in the stack the user would like to modify, or “swap out.” Modifying one or more stacks can include swapping out a default software module and replacing the default software module with a customized software module, which can be done as long as the interface and dependency constraints remain in place in the modified stack.

In one embodiment, a user (e.g., a product vendor) can interact with an interface (such as to swap out a program module) through the use of instance structures. Every instance structure has several pointers. In one embodiment, one such pointer is a pointer to a list of functions the user (e.g., a product vendor, or employee or contractor thereof) can use. In one embodiment, another pointer is a pointer to a configuration structure. Whenever an embedded software application, stack, and/or software module makes use of an interface, an instance structure can be associated with the interface. In such embodiments, a user can access the underlying code through the instance structure. If a user want to swap out the underlying module or code, the user can use a software program to create a new instance structure and point the embedded software application and/or stack to that new instance structure. In one embodiment, a user can makes these changes without providing any software code himself or herself. Moreover, the user can make these changes without directly viewing or interacting with the underlying software code at all. Method 500 receives any such instructions to create, modify, or swap out one or more software modules in step 520.

Method 500 then creates a modified stack of software modules in step 530. Importantly, in one embodiment, the modified stack is created without allowing the user to access the underlying software code itself. Rather, the changes are effectuated by the user interacting with a software module's interface after the stack is displayed in step 510. Method 500 then receives instructions from the user in step 520, where the instructions received from the user allow method 500 to perform step 530 without granting the user access to the underlying software code itself. As was indicated above, this structure and functionality enables users to swap modules in and out to suit their needs and the needs of their products, but without any risk of introducing errors into (or otherwise compromising the integrity of) the underlying software code (such as is found in the underlying software modules, stack(s), and embedded software application(s)).

After all requested modifications to the stack have been made (or at any other point so designated by the user), method 500 then compiles the modified stack of software modules in step 540. Compiling the modified stack of software modules produces compiled computer instructions that are optimized for use with a microcontroller. As such, these compiled computer instructions can be optimized in light of the various constraints and considerations discussed above, especially with respect to the limited memory that is typically available on a microcontroller chip. After the software instructions are compiled in step 540, method 500 then “flashes” or otherwise uploads the compiled instructions to the microcontroller in step 550. These compiled instructions will generally be stored in a non-transient computer-readable storage medium located on the microcontroller chip, such as memory 120. Method 500 then concludes.

### Example Computer System

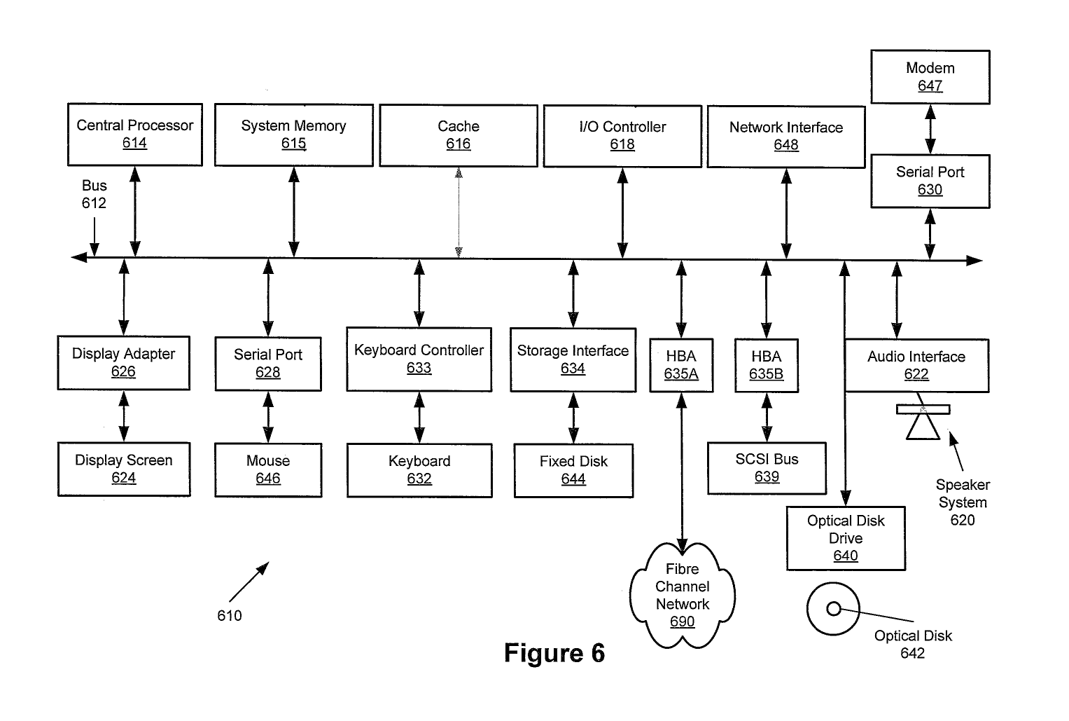

As shown above, the systems described herein can be implemented using a variety of computer systems. Examples of one such computing environment is described below with reference to FIG. 6.

FIG. 6 depicts a block diagram of a computer system 610 suitable for implementing aspects of the systems described herein. Computer system 610 includes a bus 612 which interconnects major subsystems of computer system 610, such as a central processor 614, a system memory 615 (typically RAM, but which may also include ROM, flash RAM, or the like), a cache 616, an input/output controller 618, an external audio device, such as a speaker system 620 via an audio output interface 622, an external device, such as a display screen 624 via display adapter 626, serial ports 628 and 630, a keyboard 632 (interfaced with a keyboard controller 633), a storage interface 634, a host bus adapter (HBA) interface card 635A operative to connect with a Fibre Channel network 690, a host bus adapter (HBA) interface card 635B operative to connect to a SCSI bus 639, and an optical disk drive 640 operative to receive an optical disk 642. Also included are a mouse 646 (or other point-and-click device, coupled to bus 612 via serial port 628), a modem 647 (coupled to bus 612 via serial port 630), and a network interface 648 (coupled directly to bus 612).

Bus 612 allows data communication between central processor 614 and system memory 617, which may include read-only memory (ROM) or flash memory (neither shown), and random access memory (RAM) (not shown), as previously noted. RAM is generally the main memory into which the operating system and application programs are loaded. The ROM or flash memory can contain, among other code, the Basic Input-Output System (BIOS) which controls basic hardware operation such as the interaction with peripheral components. Applications and/or software, such as those discussed herein, resident with computer system 610 are generally stored on and accessed from a computer-readable storage medium, such as a hard disk drive (e.g., fixed disk 644), an optical drive (e.g., optical drive 640), or other computer-readable storage medium.

Storage interface 634, as with the other storage interfaces of computer system 610, can connect to a standard computer-readable medium for storage and/or retrieval of information, such as a fixed disk drive 644. Fixed disk drive 644 may be a part of computer system 610 or may be separate and accessed through other interface systems. Modem 647 may provide a direct connection to a remote server via a telephone link or to the Internet via an internet service provider (ISP). Network interface 648 may provide a direct connection to a remote server via a direct network link to the Internet via a POP (point of presence). Network interface 648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 6 need not be present to practice the systems described herein. The devices and subsystems can be interconnected in different ways from that shown in FIG. 6. The operation of a computer system such as that shown in FIG. 6 is readily known in the art and is not discussed in detail in this application. Code to implement the modules of the systems described herein can be stored in computer-readable storage media such as one or more of system memory 617, fixed disk 644, or optical disk 642. The operating system provided on computer system 610 may be MS-DOS®, MS-WINDOWS®, UNIX®, Linux®, AIX®, or another operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
displaying representation of an initial stack of software modules to a user, wherein
each software module in the initial stack is dependent upon at least one other software module in the stack, and
the stack is configured for use in an embedded memory of a microcontroller;
receiving instructions to modify the initial stack of software modules to create a modified stack of software modules, wherein
creating the modified stack comprises replacing at least one software module from the initial stack with a user-defined software module;
compiling the modified stack of software modules to produce compiled computer instructions;
flashing the embedded memory of the microcontroller with the compiled computer instructions,
wherein
the flashing the embedded memory stores the compiled instructions in the embedded memory, and
the compiled instructions are configured to control the functionality of the microcontroller.

2. The method of claim 1, wherein
the user does not have direct access to computer code that defines the software modules in the initial stack.

3. The method of claim 2, wherein
the user accesses the computer code indirectly through the use of an interface, wherein each software module comprises a respective interface.

4. The method of claim 3, wherein
the respective interface of each software module defines a set of functionality that must be supported by each respective software module, and
the respective interface of each software module is customized for use with the corresponding software module.

5. The method of claim 1, wherein
the compiled computer instructions are optimized for use by a microcontroller that comprises less than three megabytes of memory.

6. The method of claim 1, wherein
the initial stack comprises at least a first software module, a second software module, and a third software module, wherein
the first software module is dependent on information received from the second software module,
the second software module is dependent on information received from the third software module, and
the first software module is not configured to directly communicate with the third software module.

7. The method of claim 1, wherein
the compiling the modified stack comprises selectively including at least one command from a predefined software library file, without including the entire predefined software library file.

8. A system comprising:
a micrprocessor;
a computer screen;
a non-transient computer-readable memory, comprising computer instructions executable by the microprocessor, wherein the instructions are configured to perform a method comprising the steps of:
displaying a representation of an initial stack of software modules to a user, wherein
each software module in the initial stack is dependent upon at least one other software module in the stack, and
the stack is configured for use in an embedded memory of a microcontroller;
receiving instructions to modify the initial stack of software modules to create a modified stack of software modules, wherein
creating the modified stack comprises replacing at least one software module from the initial stack with a user-defined software module;
compiling the modified stack of software modules to produce compiled computer instructions;
flashing the embedded memory of the microcontroller with the compiled computer instructions, wherein
the flashing the embedded memory stores the compiled instructions in the embedded memory, and
the compiled instructions are configured to control the functionality of the microcontroller.

9. The system of claim 8, wherein
the user does not have direct access to computer code that defines the software modules in the initial stack.

10. The system of claim 9, wherein
the user accesses the computer code indirectly through the use of an interface, wherein
each software module comprises a respective interface.

11. The system of claim 10, wherein
the respective interface of each software module defines a set of functionality that must be supported by each respective software module, and
the respective interface of each software module is customized for use with the corresponding software module.

12. The system of claim 8, wherein
the compiled computer instructions are optimized for use by a microcontroller that comprises less than three megabytes of memory.

13. The system of claim 8, wherein
the initial stack comprises at least a first software module, a second software module, and a third software module, wherein
the first software module is dependent on information received from the second software module,
the second software module is dependent on information received from the third software module, and
the first software module is not configured to directly communicate with the third software module.

14. The system of claim 8, wherein
the compiling the modified stack comprises selectively including at least one command from a predefined software library file, without including the entire predefined software library file.

15. A computer program product, comprising a plurality of program instructions stored on a non-transient computer readable storage medium, wherein the instructions are configured to execute a method comprising the steps of:
displaying a representation of an initial stack of software modules to a user, wherein
each software module in the initial stack is dependent upon at least one other software module in the stack, and
the stack is configured for use in an embedded memory of a microcontroller;
receiving instructions to modify the initial stack of software modules to create a modified stack of software modules, wherein
creating the modified stack comprises replacing at least one software module from the initial stack with a user-defined software module;
compiling the modified stack of software modules to produce compiled computer instructions;
flashing the embedded memory of the microcontroller with the compiled computer instructions, wherein
the flashing the embedded memory stores the compiled instructions in the embedded memory, and
the compiled instructions are configured to control the functionality of the microcontroller.

16. The computer program product of claim 15, wherein
the user does not have direct access to computer code that defines the software modules in the initial stack.

17. The computer program product of claim 16, wherein
the user accesses the computer code indirectly through the use of an interface, wherein
each software module comprises a respective interface.

18. The computer program product of claim 17, wherein
the respective interface of each software module defines a set of functionality that must be supported by each respective software module, and
the respective interface of each software module is customized for use with the corresponding software module.

19. The computer program product of claim 15, wherein
the initial stack comprises at least a first software module, a second software module, and a third software module, wherein
the first software module is dependent on information received from the second software module,
the second software module is dependent on information received from the third software module, and
the first software module is not configured to directly communicate with the third software module.

20. The computer program product of claim 15, wherein
the compiling the modified stack comprises selectively including at least one command from a predefined software library file, without including the entire predefined software library file.
